(19) United States
(12) Patent Application Publication
(10) Pub. No.: US 2025/0347360 A1
(43) Pub. Date: Nov. 13, 2025

(54) SCAFFOLD TO PIPE COUPLING

(71) Applicant: A. Lawrence Berry, Houston, TX (US)

(72) Inventor: A. Lawrence Berry, Houston, TX (US)

(21) Appl. No.: 19/207,153

(22) Filed: May 13, 2025

Related U.S. Application Data
(60) Provisional application No. 63/646,410, filed on May 13, 2024.

(51) Int. Cl. F16L 3/10

(52) U.S. Cl. CPC F16L 3/1075; F16L 3/1058

(57) ABSTRACT

A coupling may be configured for use in mounting scaffolding to a pipe or vice versa. The coupling may include a saddle shaped to receive the pipe so that the pipe may be seated within the saddle. The coupling may further include a tensioning arm pivotably mounted to the saddle. A flexible band may be secured to the tensioning arm and configured for wrapping around the pipe. An adjustment assembly may be connected to the tensioning arm. The adjustment assembly may be configured for actuation so as to adjust a level of tension in the flexible band.

### CROSS-REFERENCE TO RELATED APPLICATION

This application claims priority to U.S. Provisional Patent Application No. 63/646,410 titled “Scaffold to Pipe Coupling” filed May 13, 2024. The disclosure of the aforementioned patent application is herein fully incorporated by reference.

### FIELD

The disclosed apparatuses and methods described herein generally relate to industrial scaffold assembly.

### BACKGROUND

This section is intended to provide a background or context to the invention that is recited in the claims. Therefore, unless otherwise indicated herein, what is described in this section is not admitted to be prior art to the description and claims in this application.

There exists a need for methods and apparatuses for coupling pipes and scaffolding in an industrial plant or similar facility, maintenance site, construction site, or other setting. For example, a pipe (e.g., a damaged pipe or pipe in need of maintenance) may need to be supported using scaffolding and a coupling support during maintenance and repair of piping. A coupling support may also be used to link scaffolding to an existing pipe at a facility or other place. These places may include, for example, existing petrochemical facilities, paper mills, power generation plants, and so forth. Such places may also include a solitary pipe rack offsite of a facility. More generally, any place in which a pipe is installed may be used as a support element for a scaffold using couplings as described herein.

Often times, it may be difficult to find available floor space when constructing scaffolding in such places. Accordingly, in some embodiments herein, couplings may be used to mount scaffolding to installed pipes in an industrial plant or similar setting without requiring the use of floor space. In some embodiments, couplings herein may be used for mounting scaffolding to sections of pipe that may have installed valves or projecting fittings that need to be worked around. For example, the couplings herein may include one or more flexible bands that may, for example, be positioned around or over irregularities, valves, or fittings in a given section of piping. Accordingly, scaffolding may be constructed in areas of an industrial plant that may otherwise be difficult to access.

### SUMMARY

A coupling comprising a saddle including a first end, a second end, and an inner surface, the inner surface of the saddle being shaped to receive a pipe so that the pipe may be seated within the saddle. The coupling further includes a tensioning arm pivotably mounted to the saddle at the first end of the saddle. A flexible band may be secured to the tensioning arm and configured for wrapping around at least a portion of the pipe when the pipe is seated within the saddle, the flexible band including a connector for securement of the flexible band to the saddle at the second end of the saddle; and an adjustment assembly connected to the tensioning arm, the adjustment assembly be configured for actuation so as to adjust a level tension in the flexible band.

It is an objective of some embodiments herein to provide a coupling for securing scaffolding to piping and vice versa wherein load induced stresses are reduced.

It is an objective of some embodiments herein to provide a coupling of limited weight that may be easily carried by a worker in a method of construction, maintenance, or repair of industrial piping.

### BRIEF DESCRIPTION OF THE DRAWINGS

FIG. 1 is a perspective view of an embodiment of a coupling support configured for connecting scaffolding to a pipe or conduit.

FIG. 2 is a side elevation view of the coupling support of FIG. 1 shown engaged with a pipe.

FIG. 3A is a side elevation view of another embodiment of a coupling support including a tensioning arm and a lever.

FIG. 3B is a side elevation view of another embodiment of a coupling support.

FIG. 4A is a side elevation view of the coupling support of FIG. 1 shown engaged with a pipe.

FIG. 4B is a side elevation view of the coupling support of FIG. 1 shown engaged with a pipe.

FIG. 5 is a side elevation view of another embodiment of a coupling including a liner or coating.

FIG. 6 is a side elevation view of another embodiment of a coupling including a plurality of scaffold connectors.

FIG. 7 is a rear elevation view of an embodiment of a saddle.

FIG. 8A is a top plan view of an embodiment of a flexible band.

FIG. 8B is a perspective view of another embodiment of a flexible band.

FIG. 9A is a backside elevation view of an embodiment of an adjustment lever.

FIG. 9B is a side view of a receiving mount configured for receiving the adjustment lever shown in FIG. 9A.

FIG. 10 is a perspective view of still another embodiment of a coupling.

FIG. 11 is a flowchart of an embodiment of a method for securing a coupling to a pipe.

FIG. 12A is a side elevation view of an embodiment of a coupling and a pipe in a first step in a method for securing the coupling to the pipe.

FIG. 12B shows the coupling and pipe of FIG. 12A in an additional step in a method for securing the coupling to the pipe.

FIG. 12C shows the coupling and pipe of FIG. 12A and FIG. 12B in an additional step in a method for securing the coupling to the pipe.

FIG. 13A shows the coupling support of FIG. 1 and a mounting beam of scaffolding showing how a connecting screw, bolt, or pin may be used to secure the mounting beam to the coupling support.

FIG. 13B shows an alternative embodiment of a scaffolding connector including a hook.

FIG. 13C shows an alternative embodiment of a scaffolding connector including a plate with a plurality of recesses or openings enabling coupling of scaffolding thereto at any of various angles of connection.

FIG. 13D shows an alternative view of the connector shown in FIG. 13C.

FIG. 13E shows an alternative embodiment of a coupling with a scaffolding connector. The coupling is connected to a vertically oriented pipe.

FIG. 13F shows an alternative view of the connector shown in FIG. 13E.

FIG. 14 is a front elevation view of scaffolding secured to a pipe using a pair of coupling supports.

FIG. 15 is a side elevation view of an embodiment of a coupling support including an electronic actuator.

FIG. 16A shows a schematic embodiment of a saddle with a first pipe seated therein.

FIG. 16B shows the saddle of FIG. 16A with an adapter coupled thereto. The saddle and adapter are shown with a second pipe seated therein.

FIG. 16C is a side elevation view of an embodiment of a coupling, an adapter, and a pipe showing an embodiment for how the adapter may be used in securing the coupling to the pipe.

### DETAILED DESCRIPTION

As used herein, the following terms should be understood to have the indicated meanings:

When an item is introduced by “a” or “an,” it should be understood to mean one or more of that item.

“Comprises” means includes but is not limited to.

“Comprising” means including but not limited to.

“Having” means including but not limited to.

This disclosure is generally directed to coupling supports (also referred to herein as couplings) configured for anchoring scaffolding to pipes or vice versa. For example, in some embodiments, one or more couplings may be used to anchor scaffolding to one or more pipes so that the scaffolding may be suspended or supported therefrom. Scaffolding may, for example, be supported through one or more couplings and one or more pipes or other beams (e.g., supporting beams of a pipe rack) so that the scaffolding may not require anchoring to the floor of an industrial plant. In some embodiments, a coupling may be configured for use with scaffolding to help support a pipe during a method of construction, maintenance, and/or repair of industrial piping. For example, one or more couplings may be used to hold a section of a pipe in place during replacement or repair of a worn out or damaged portion of industrial piping. Accordingly, in some embodiments, scaffolding may act as a support for a pipe with one or more of the couplings described herein providing for the engagement therebetween. Alternatively, one or more pipes may serve as a support for scaffolding with linkages therebetween being provided using one or more of the couplings as described herein.

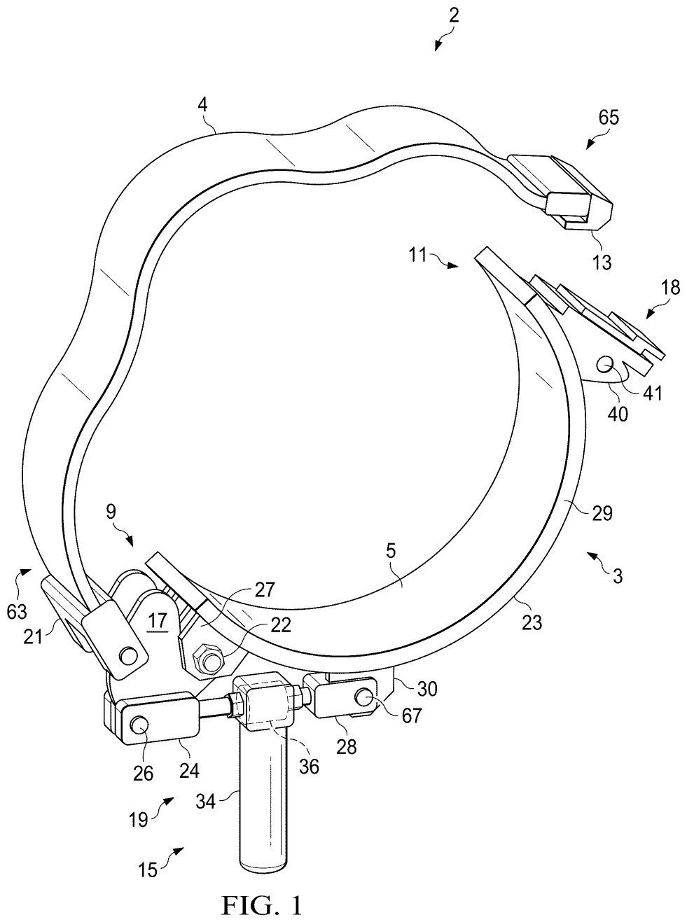

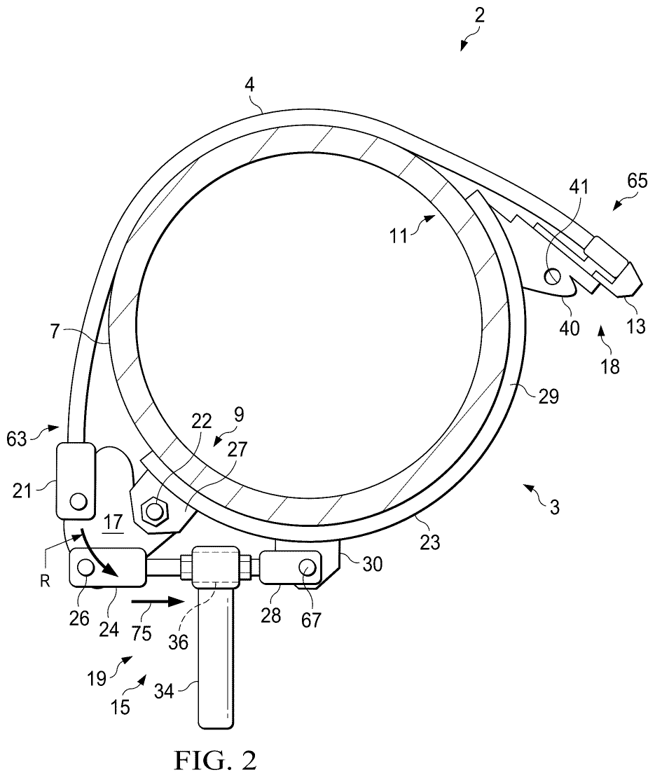

In some embodiments, a coupling may include a saddle and a flexible band coupled to the saddle to secure the saddle to the band. Generally, saddles as described herein may be shaped so that a portion of a pipe may sit cradled within the saddle. The flexible band may then be generally wrapped around a remaining portion of the pipe so that the coupling surrounds or encompasses the pipe so as to retain the pipe in the saddle. For example, the flexible band may be secured at a first side of the saddle through a tensioning assembly and wrapped around an exterior surface of the pipe so that it generally extends from the first side of the saddle to the opposite side of the saddle and hooked or otherwise connected thereto. Once the band has been connected (e.g., hooked in place so that it extends from side of the saddle to the opposite side of the saddle), a worker may use the tensioning assembly to increase tension in the band when securing the coupling to the pipe. The tension may be sufficiently tight to prevent the pipe from sliding or twisting in the saddle. Or, the tension may be sufficient to retain the pipe in the saddle yet permit the pipe to slide or wiggle within the saddle. For example, FIG. 1 shows an embodiment of a coupling 2 including a saddle 3, a flexible band 4, and a tensioning assembly 15. In FIG. 2, the coupling 2 is shown with a first portion of the pipe 7 seated cradled within the saddle 3 and with the flexible band 4 wrapped around a second portion of the pipe 7 and connected to the saddle 3 using a connector 13. As shown in FIGS. 1 & 2, the connector 13 may be embodied as a hook and may be engaged with a corresponding connector 18 of the saddle 3. An associated connector 18 may be embodied as a hook plate such as may, for example, include a groove, opening, or recess suitable for receiving the hook. A tensioning assembly 15 may then be used to increase tension in the flexible band 4 so as to secure the coupling 2 to the pipe 7.

In some embodiments, a tensioning assembly may comprise a tensioning arm operatively engaged with an adjustment assembly. For example, as shown in FIGS. 1 & 2, a tensioning assembly 15 may include a tensioning arm 17 coupled with an adjustment assembly 19. As shown therein, a first end 63 of the flexible band 4 may be connected to the saddle 3 through the tensioning arm 17. The flexible band 4 may be wrapped around the pipe 7 so that a second end 65 of the band 4 is also connected the saddle 3. For example, in the illustrated embodiment shown in FIGS. 1 & 2, the flexible band 4 is connected to the saddle 3 at the second end 11 of the saddle 3 using a connector 13 so that the coupling 2 generally encircles or surrounds the pipe 7. The tensioning arm 17 may be pivotably coupled to the saddle at pivot 22 and pivotably coupled to the adjustment assembly 19 at pivot 26. The tensioning arm 17 may be operatively engaged with the adjustment assembly 19 so that changes in a length of the adjustment assembly 19 between the pivot 26 and the pivot 67 effect rotation of the tensioning arm 17. An adjustment assembly 19 that is configured to adjust a tensioning arm 17 based on changes of length may sometimes be referred to herein as a length adjustment assembly 19. An adjustment assembly 19 may, for example, be actuated so as to move the tensioning arm 17 between different positions so that tension in the flexible band 4 may be increased or decreased. For example, as shown in FIG. 2, a change in length of the adjustment assembly 19 (see arrow 75) may move the tensioning arm 17 so that the tensioning arm 17 rotates R about a pivot 22 in a direction to generally increase a distance that the flexible band 4 must extend so as to wrap around a portion of the pipe 7 (e.g., a remaining portion of the pipe not seated in the saddle 3). Thus, the rotation R in the direction shown in FIG. 2 may take up any slack in the flexible band 4 (if any is present) and increase tension in the band 4. Likewise, rotation in the opposite direction of R may decrease tension in the flexible band 4.

In some embodiments, a tensioning arm may be rotated in one direction so that tension in the band initially increases but further rotation of the tensioning arm moves the band past a point of maximum tension so that band tension slightly decreases. Likewise, rotation of a tensioning arm in the opposite direction may initially increase tension before tension in the band is decreased. Rotation of a tensioning arm 17 may, for example, act upon a flexible band 4 through movement of the connector (see connector 21, for example) by which the flexible band 4 is secured to the tensioning arm. For example, the band 4 may be secured to the tensioning arm 17 using a connector 21 such as a D-ring, shackle, u-bolt, or other appropriate connection device. As shown in FIG. 2, the connector 21 may generally rotate R about the pivot 22 when the adjustment assembly 19 is actuated (see arrow 73). Generally, the size of the tensioning arm 17, position of the pivot 22, and position at which the connector 21 is connected to the tensioning arm 17 may affect the path through which the connector 21 moves during this rotation. Accordingly, changes in tension of the band 4 during rotation may also be controlled. For example, tension may be adjusted through rotation that the band 4 experiences an intermediate state of maximum tension before the tension is slightly decreased. In some embodiments, changes in tenson of the band 4 through rotation of the tensioning arm 17 may help to secure the band 4 in place. For example, to unhook the flexible band 4 from a mount or hook plate 18 to which it is connected, the flexible band 4 may be required to stretch so that the tension in the band 4 would at least transiently increase thereby helping to keep the band in place. In some such embodiments, a tension release lever or other release mechanism (not shown) may be provided so as to assist in releasing band tension and removing the coupling from a pipe.

In some embodiments, rotation of the tensioning arm 17 may be controlled using a length adjustment assembly 19 such as may be embodied as one of a turnbuckle, stretching screw, electronic or otherwise powered actuator, load binder, strap ratchet, lashing winch, or other suitable apparatus configured for length adjustment. For example, the coupling 2 may comprise a tensioning arm 17 which, in the illustrated embodiment shown in FIG. 1, is coupled to an adjustment assembly 19 embodied in the form of a turnbuckle. The tensioning arm 17 is operatively engaged with the turnbuckle 19 so that translation of the turnbuckle 19 may initiate controlled rotation of the tensioning arm 17 and concomitant adjustment of tension in the flexible band 4.

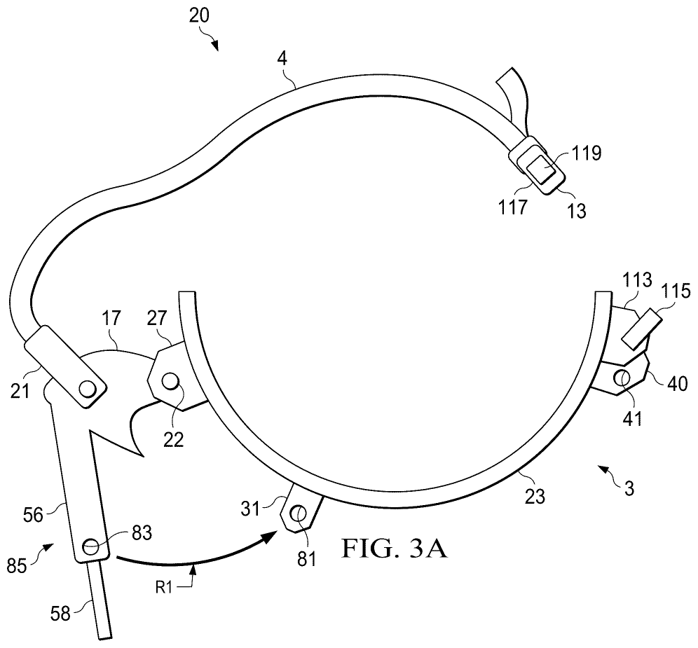

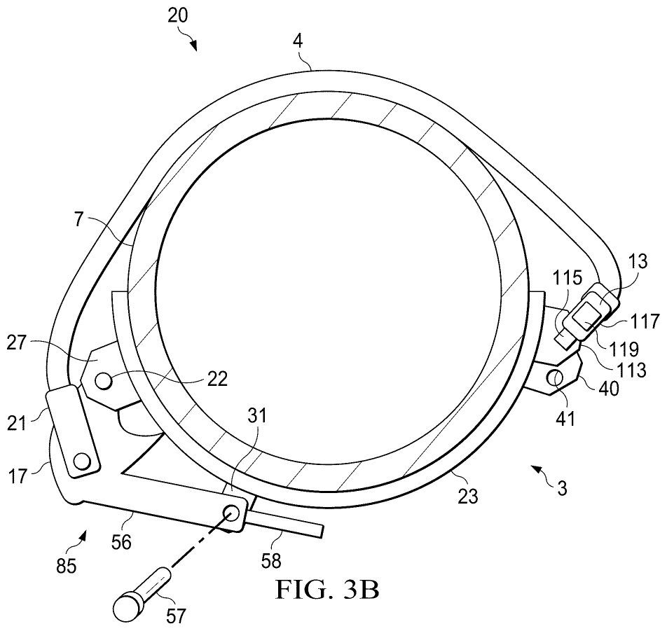

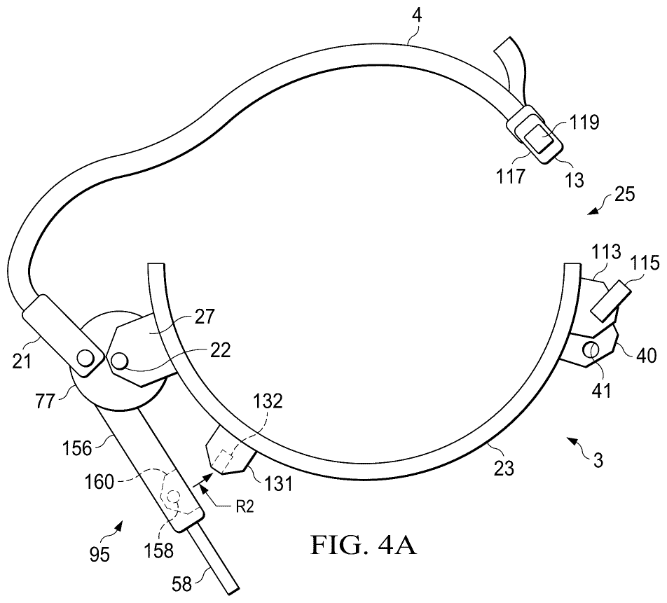

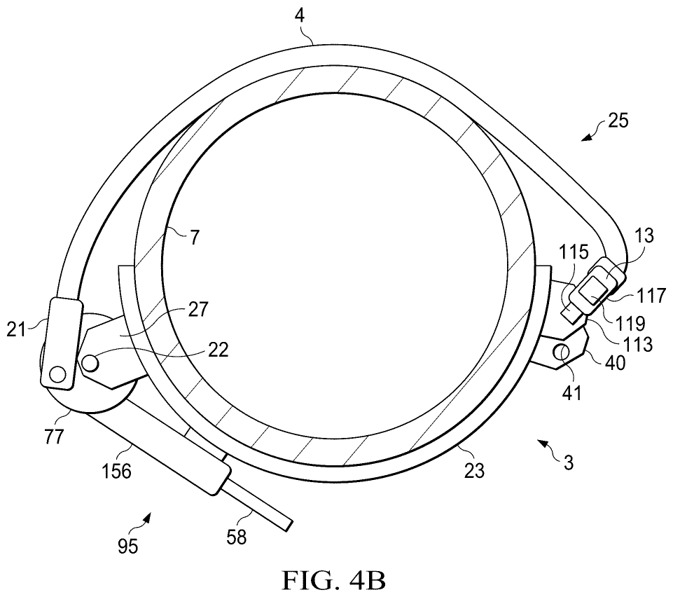

In some embodiments, a tensioning assembly may comprise a tensioning arm operatively engaged with an adjustment lever. For example, an adjustment lever may be used to control rotation of a tensioning arm. A lever may, for example, be actuated so as to adjust the position of the tensioning arm between a first state wherein the tensioning arm is adjusted to a position providing minimal tension in the band and a second state wherein the tensioning arm is adjusted to a position increasing tension in the band. With the lever in the first position, a user may easily wrap the flexible band around a pipe and connect the flexible band to the saddle (e.g., by hooking the band to a hook plate or other mount positioned at the second end of the saddle). Once the flexible band is wrapped around the pipe and hooked in place to the saddle, a user may actuate the lever, thereby moving the lever to the second position so as to increase tension in the band. A removable anchor pin may sometimes be used to help secure the lever in place at the second state so as to prevent inadvertent movement of the adjustment lever and release of tension in the band. For example, couplings 20, 25 are shown, respectively, in FIGS. 3A, 3B and FIGS. 4A, 4B. As shown in FIGS. 3A & 3B, the coupling 20 includes the tensioning assembly 85 which includes tensioning arm 17 and the adjustment lever 56. A handle 58 may be connected to the adjustment lever 56. As shown in FIGS. 4A & 4B, coupling 25 includes the tensioning assembly 95 which includes tensioning arm 77 and the adjustment lever 156. In some embodiments, an adjustment lever 56, 156 may be manually actuated from a first state (shown in FIGS. 3A, 4A) to a second state (shown in FIGS. 3B, 4B) and locked in place using a locking pin 57.

As shown in FIGS. 1-4, couplings 2, 20, 25 may include a saddle 3 and a flexible band 4 (sometimes referred to herein as securement band 4). The saddle 3 may include a curved plate 23 formed so that an inner face 5 of the saddle 3 is curved. An outer edge 29 of the curved plate 23 may generally form a semi-circle. Thus, as shown in FIG. 2, for example, the saddle 3 may be shaped so that its inner face 5 may abut against and generally follow the contour of the outer surface of a cylindrically shaped pipe 7 when the coupling support 2 is engaged therewith. For example, FIG. 2 shows cylindrically shaped pipe 7 seated within the saddle 3 of the coupling 2 so that the outer surface of the pipe 7 generally abuts against the inner face 5 of the saddle 3.

In the illustrated embodiments shown in FIGS. 1-4, curved plate 23 is shaped so that its outer edge 29 may form a half-circle. Thus, the inner face 5 may abut against an outer surface of the pipe 7 and engage with the outer surface of the pipe over a region extending a distance of about ½ of a perimeter distance around the pipe 7. Alternatively, a saddle 3 may be shaped differently so that it may, for example, abut against some other portion of a perimeter distance around the pipe 7. For example, in some embodiments, a curved plate 23 of the saddle 3 may be shaped so that its outer edge 29 forms a semi-circle. An inner face 5 of the curved plate 23 may be configured so that it abuts against a length of less than about ½ of the overall perimeter distance around the pipe 7 when the pipe 7 is seated in the saddle 3. In some embodiments, a saddle 3 may include a curved plate 23 including an inner face 5. The inner face 5 of the curved plate may be configured so that it abuts against a length of less than about ⅓ of the overall perimeter distance around the pipe 7 when the pipe 7 is seated in the saddle 3. In some embodiments, a curved plate 23 may generally be sized at a minimum dimension so that it may provide a base upon which at least one scaffolding connector 40, 400 and a tensioning assembly 15, 85, 95 may be mounted. More generally, some embodiments herein are directed to couplings 2, 20, 25, 120, 200 (or other couplings described herein) with differing sizes of saddles 3 and bands 4.

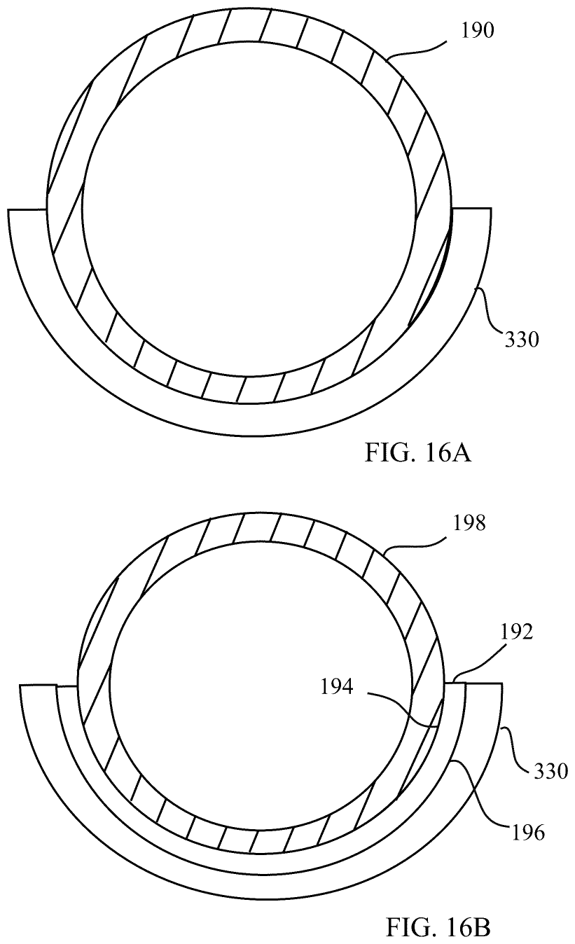

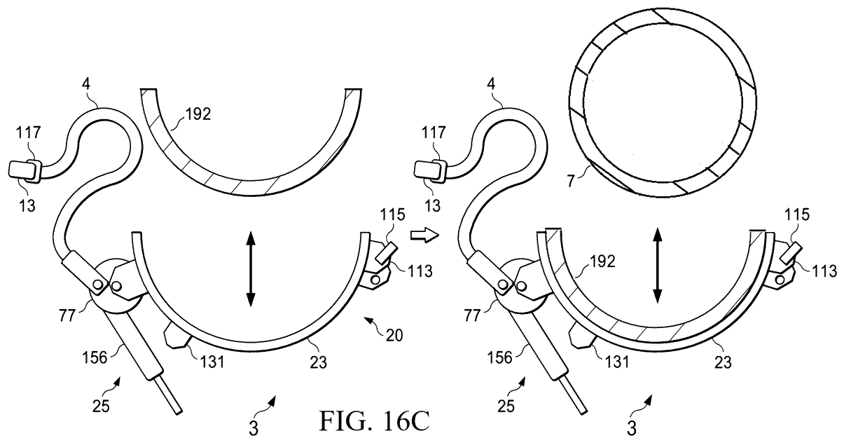

In yet other embodiments, a saddle may be sized for use with a range of pipe diameters. The saddle may be sized to accommodate a pipe having the largest diameter of the range of pipe diameters. Pipes of smaller diameters may be seated in the saddle with an adapter. A plurality of adapters may be provided, with each adapter corresponding to a pipe diameter. Each adapter may have an outer radial size curve sized to seat within the saddle and an inner radial curve sized to receive a pipe of a corresponding diameter. For example, FIGS. 16A & 16B show an embodiment of a saddle 330 configured for use with one or more adapters. As shown in FIG. 16A, the saddle 330 may be configured so as to receive a first pipe 190. The first pipe 190 may, for example, be a pipe having the largest diameter among a range of different pipes for which the saddle 330 may receive. As shown in FIG. 16B, the saddle 330 may also be used with an adapter 192. As shown in FIG. 16B, the adapter 192 may include an inner wall 194 and an outer wall 196. The outer wall 196 of the adapter 192 may be shaped so that the adapter 192 may be seated within the saddle 330. The inner wall 194 of the adapter 192 may be shaped so that the adapter 192 may receive a pipe 198. The pipe 198 has a smaller diameter than the pipe 190. FIG. 16C shows an embodiment for how the coupling 20 (also shown in FIG. 3A & 3B) may be used with an adapter 192 so that a pipe 7 may be received therein. Of course, other couplings 2, 25, 120, 145, 200, 220 described herein may also be used with an adapter 192. As shown in FIG. 16C, the adapter 192 may first be seated within the saddle 3 of the coupling 20. The pipe 7 may then be seated with the adapter equipped coupling 20. Generally, in some embodiments, the adapters 192 as described herein may be configured similarly to the saddle. For example, as also described herein with respect to some embodiments of saddles, adapters 192 may be configured to help prevent marring. For example, in some embodiments, an adapter 192 may be made of a high strength polymer so that it may directly interface with a pipe 7 without damaging the pipe. A coating or liner may sometimes be included with an adapter 192. In some embodiments, an adapter 192 may constructed of, or lined with, electrically conductive material, such as may be used where a pipe must be electrically grounded.

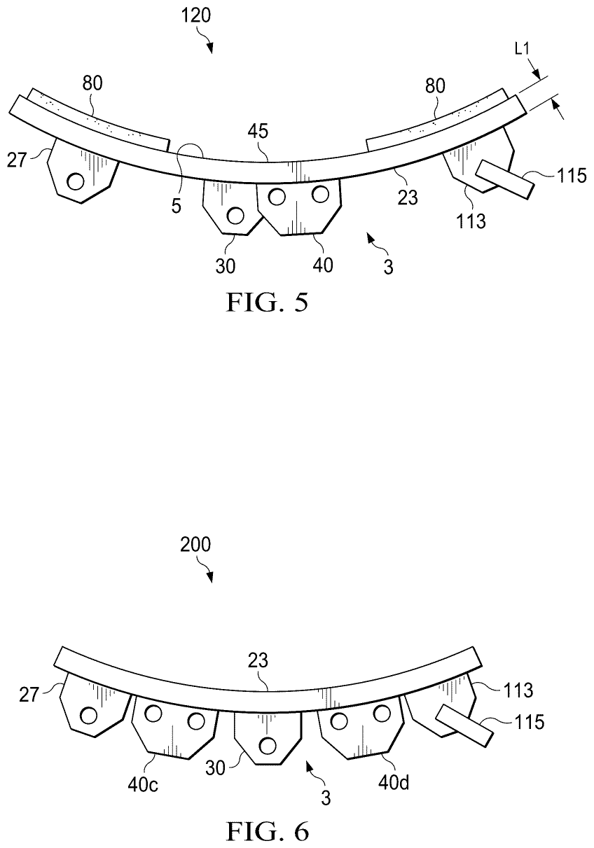

Generally, the saddle 3 (or other saddle described herein) may be constructed of any suitable material appropriate for use with a given loading and working environment intended for the coupling 2 (or other coupling as described herein). For example, materials used in making the saddle 3 may be selected based on whether a given coupling 2 is designed for use individually or in combination with one or more other couplings 2 for supporting a given weight of scaffolding. For example, in some embodiments, saddle 3 may be made of steel, a high strength polymer, aluminum, other metal, or some other suitable material. The saddle 3 may include an engaging inner face 5 configured so as to help prevent marring of a pipe 7 to which it may be engaged. For example, some high strength polymers, including, for example, the thermoplastic PEEK (polyetheretherketone) may, generally, interface directly with a pipe 7 (at least under suitable environmental and loading conditions) without significant risk of damage or marring of the pipe. In some embodiments, a coating or liner may be used with some materials so as to help prevent marring of a pipe 7. For example, as described further herein with respect to the coupling 120 (shown in FIG. 5), a coating or liner may be used to help prevent marring of a pipe 7. In some embodiments, the saddle may constructed of, or lined with, electrically non-conductive material. In some embodiments, the saddle may constructed of, or lined with, electrically conductive material, such as may be used where a pipe must be electrically grounded. In some embodiments, the saddle may constructed of, or lined with, a thermally insulative material for use in circumstances in which a pipe conducts fluid that must be maintained at a certain temperature. In yet other embodiments, a saddle may be magnetized or include magnetic pads to help retain a pipe before securement by a securement band. A magnetic saddle may also help retain a pipe should a securement band become loose or broken, or should a securement band be removed from a saddle.

In some embodiments, as shown, for example, in FIG. 5, a saddle 3 may be relatively thin in one or more dimensions L₁. This may be useful in providing a coupling 120 of reduced weight, for example. Likewise, some embodiments of couplings 2, 20, 25 (or other couplings described herein) may include a relatively longer band 4 in relation to a saddle 3. For example, in some embodiments, the length of curved plate 23 (e.g., the distance traced along the inner face 5 from a first end 9 of the saddle to the second end 11 of the saddle 3) may be reduced or minimized over that shown in FIG. 1 so as to provide a lighter weight coupling 2. A limited weight coupling 2 (or other coupling described herein) may, for example, be particularly useful when a worker is mounting a coupling 2 to a section of pipe from an existing scaffold in a part of an industrial plant wherein floor space is limited. In such circumstances, a worker may, generally, want to carry a coupling 2 of minimal weight in navigating or moving through the existing scaffolding. As an additional example, the coupling 200 (described further below and shown in FIG. 6) also provides a curved plate 23 of reduced overall length (as compared to the half-circle geometry of curved plate 23 illustrated in FIG. 1). The coupling 200 may be used with a flexible band 4 (not shown in FIG. 6) of suitable length to wrap around a pipe 7 and constructed as a light weight coupling 200 which may be easily carried by a worker. In some embodiments, saddles and flexible bands may be provided separately for storage and mobility. Saddles may be more readily stacked or arranged without flexible bands. In some embodiments, a stack of saddles and a corresponding bundle of flexible bands may be carried separately to a job site and assembled for use.

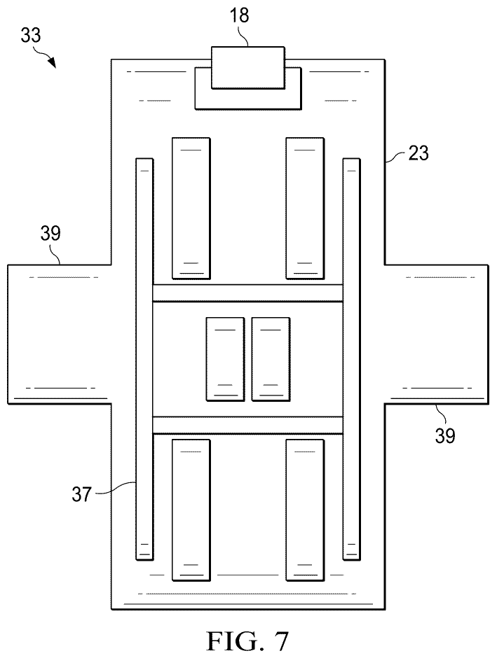

In some embodiments, an outer face of a saddle 3 may generally follow the curved shape of the inner face 5 of the saddle 3. However, in some embodiments, an outer face of the saddle 3 need not perfectly follow the shape of the inner face 5. For example, in some embodiments, one or more ribs or other features (see ribs 37 as shown in FIG. 7) may be provided on the outer face of the saddle 3. Ribs may, for example, be used to enhance the strength or rigidity of the saddle 3. In some embodiments, one or more brackets or connectors (e.g., the brackets 27, 30 and the connector 40) may be formed integrally with the saddle 3 or as removable parts of the saddle 3. For example, those components may be formed as part of a saddle 3 so that the outer surface of the saddle includes those structures.

In some embodiments, the saddle 3 may provide a base structure upon which other components may be mounted. The saddle 3 may, for example, be minimally shaped and/or sized yet still shaped and sized so as to accommodate one or more brackets, mounts, or connectors upon which various components, including, for example, a tensioning assembly 15, hook plate 18, other structure, or combinations thereof may be secured. For example, in some embodiments, brackets 27, 30 or other structures 18, 40 may be secured to the arced plate 23 of the saddle 3 via a weldment or by some other means. In some embodiments, brackets 27, 30 or other structures 18, 31, 40 may be secured to the arced plate 23 of the saddle 3 using means of attachment, including, by way of nonlimiting example, a welding, epoxy bonding, bolting, or other chemical or mechanical means. In some embodiments, brackets 27, 30 or other structures 18, 31, 40 may be integrally formed into a saddle 3 at the time manufacture of a coupling 2, for example.

In some embodiments, as shown, for example, in FIG. 1 and FIG. 2, a flexible band 4 may be mounted to the saddle 3 at a first end 9 of the saddle 3. For example, the band 4 may be mounted to the saddle 3 through tensioning arm 17, which, in the illustrated embodiment, is connected to the saddle 3 through the bracket 27. Generally, the bracket 27 may be positioned adjacent or near the first end 9 of the saddle 3. As shown in FIG. 2, the band 4 may be flexibly extended around the pipe 7 so that the saddle 3 and band 4 may generally encircle the pipe 7 and securely fasten the coupling 2 to the pipe 7. For example, the band 4 may be wrapped around the pipe 7 and secured at a second end 11 of the saddle 3 using an engaging connector 13 such as a hook, latch, or other suitable engagement structure. A user may, for example, slip a connector 13 such as may be embodied as a hook over a hook plate 18 when extending the band 4 around the pipe 7 and securing the band 4 at or near the second end 11 of the saddle 3. In some embodiments, a connector 13 may work together with an additional securing pin or other secondary locking mechanism so as to help securely engage the band 4 to the saddle 3.

Generally, a band 4 may be made of any suitable flexible material of sufficient strength to wrap around and engage with a pipe 7 or other conduit and to withstand the necessary forces to secure the pipe 7 and scaffold together. For example, in some embodiments, a plurality of couplings 2 may be used to secure a pipe 7 and scaffold together so that forces subjected on the band 4 may be distributed over the plurality of couplings 2. More generally, in some embodiments, any of the various couplings 2, 20, 25, 120, 145, 200, 220 described herein may be used individually or in combination to support scaffolding using one or more pipes, or vice versa.

In some embodiments, a band 4 may include a strap, chain, wire rope, or sling, for example. In some embodiments, a band 4 may be particularly configured to stretch around or over irregularities of a pipe, conduit, or beam upon which a coupling 2 is mounted. For example, in some embodiments, a band 4 may include one or more openings (as may, for example, be found in a wire mesh), which may be sized to fit around a valve or other protruding feature of a pipe 7. Similarly, a band may comprise a plurality of separate strands that may be separated so that a protruding feature of a pipe may extend through the band.

Generally, the band 4 may be sized so that a user may easily wrap the band 4 around a pipe 7 of an intended diameter or diameter range and latch the band 4 in place (using a connector 13 or hook and a hook plate 18, for example). The band 4 may then be tightened so as to firmly engage with the pipe 7. For example, as shown in FIG. 1 and FIG. 2, in some embodiments, the band 4 may be secured at or near the first end 9 of the saddle 3 using a tensioning assembly 15. The band 4 may be long enough so that a worker may easily wrap the band 4 around the pipe 7. The worker may then use the tensioning assembly 15 to increase tension in the band and secure the band 4 and coupling 2 in place around a pipe 7. The tensioning assembly 15 may further be configured to allow a user to release tension in the band 4 when the coupling 2 is disengaged from the pipe 7. In some embodiments, a secondary tension release lever may be used in combination with a turnbuckle or other length adjustment assembly 19 to release tension in a band 4 when a coupling 2 is disengaged from the pipe 7. As a safety feature, a locking mechanism may sometimes be used so as to prevent inadvertent actuation of the adjustment assembly 19 and concomitant release of tension from a band 4. For example, in some embodiments wherein the tensioning assembly 15 includes a turnbuckle, a turnbuckle locking clip may be used to fix the turnbuckle in a desired state.

In some embodiments, a coupling may be either manually or electronically controlled. For example, as described above, in FIGS. 1-4, a tensioning arm 17, 77 may be controlled via either of a turnbuckle 19 or a lever 56, 156. In some embodiments, a turnbuckle 19 or a lever 56, 156 may be manually controlled. For example, in the illustrated embodiment of FIGS. 1 & 2, turnbuckle 19 is shown engaged with a handle 34 which may allow a user to manually adjust the length of the turnbuckle 19. For example, the band 4 may be secured to the tensioning arm 17 using a connector 21 such as a D-ring, shackle, u-bolt, or other appropriate connection device. The tensioning arm 17 may further be pivotably mounted to the saddle 3. For example, the tensioning arm 17 may be pivotably mounted to the first bracket 27 of the saddle 3 via first pivot pin 22. As shown in FIG. 1, the tensioning arm 17 is further operatively engaged with the turnbuckle 19. For example, tensioning arm 17 may be connected to the turnbuckle 19 via the first end 24 thereof (using second pivot pin 26). The turnbuckle 19 may be further connected to the saddle 3 at a second end 28 (see second bracket 30 and associated pin 67). Upon manual actuation, turnbuckle 19 may react against the second bracket 30 and engage with the tensioning arm 17 so as to rotate the tensioning arm 17 about the hinge 22 (sometimes referred to herein as the pivot) thereby adjusting tension in the band 4.

In the illustrated embodiment shown in FIG. 1, the adjustment assembly 19 is embodied as a turnbuckle. As understood in the art, a turnbuckle may include a body engaged with a left-hand thread at one end and a right-hand thread at the other end. Accordingly, actuation of the body may change the length of the turnbuckle without twisting the ends 24, 28 thereof. In some embodiments, a turnbuckle or other adjustment assembly may include a means such as a handle, crank, or ratchet facilitating its actuation. For example, as shown in FIG. 1, the turnbuckle 19 includes a body 36 and a handle 34. The body 36 is shown in FIG. 1 using a dashed line as it is generally covered by the handle 34 and positioned underneath the handle 34 in the illustrated embodiment. The handle 34 is configured to allow a user to easily rotate the body 36 of the turnbuckle when changing the length of the assembly 19 and concomitant adjustment of tension in the band 4. For example, in some embodiments, the handle 34 may include a ratchet and may be configured so that reciprocating motion of the handle 34 allows the body 36 to be rotated continuously in one direction. The ratchet may be switched so that reciprocating motion of the handle 34 allows the body 36 to be rotated continuously in the opposite direction so as to loosen tension in the flexible band. Thus, in some embodiments, the handle 34 may sometimes be referred to as a ratchet handle.

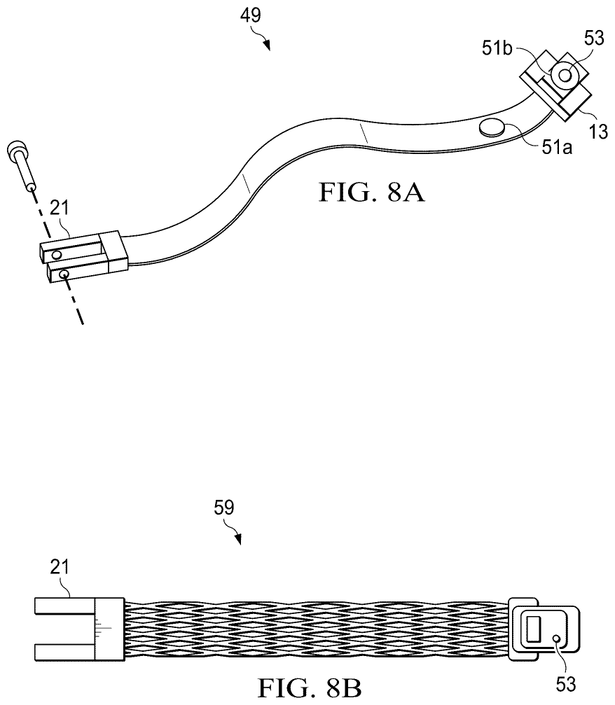

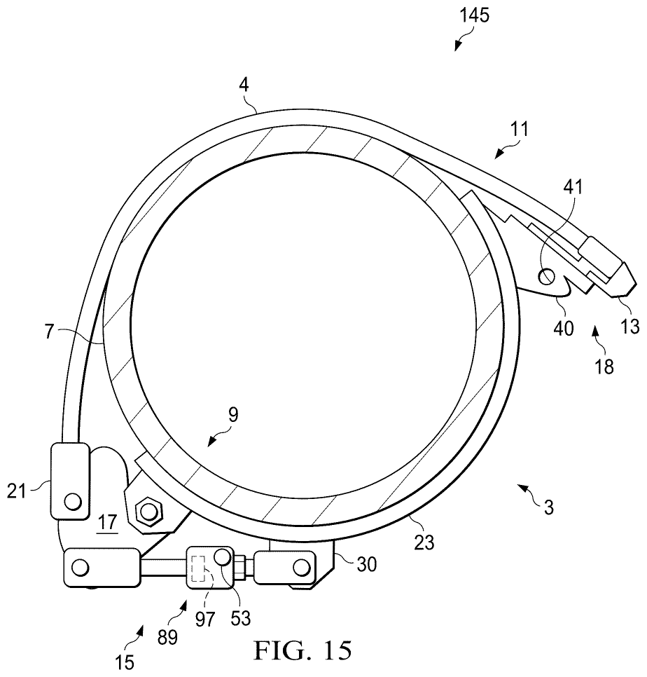

Thus, in some embodiments, the adjustment assembly 19 may be manually operable to adjust tension in the band 4 such as using a turnbuckle 19 or a lever 56, 156, for example. However, in other embodiments, the adjustment assembly 19 may be controlled electronically. For example, FIG. 15 shows an embodiment of a coupling 145. As shown therein, a linear actuator 89 has been substituted in place of the turnbuckle 19. A worker may, for example, latch a flexible band 4 via its associated connector 13 to a corresponding connector 18 of the saddle 3. The worker may then electronically actuate the adjustment assembly 89. In some embodiments, actuator 89 may, for example, execute a length adjustment procedure until a tension related counterforce is measured. For example, in the illustrated embodiment shown in FIG. 15, the actuator 89 includes a sensor or sensor array 97. The sensor or sensor array 97 may, for example, include one or more sensors configured for measuring forces incident on the actuator 89 and related to tension 4 of the band. In some embodiments, a tension related force measured by the actuator 89 may be measured together with one or more other force measurements, including for example, those described below and involving one or more sensors (see sensors 51a, 51b integrated with the band 49 and connector 13, as shown in FIG. 8A) as may be integrated together with a band or connector, for example. For example, tension may be measured using one or more tension sensors such as may, for example, be disposed along or interwoven in the band 49. Still in other embodiments, a tension related counterforce may be measured at the second end of the saddle (e.g., via a sensor disposed in the connector 13 and/or corresponding connector 18, such as the hook plate 18 illustrated in FIG. 1, for example).

In some embodiments, one or more of the sensors or sensor arrays 51a, 51b, 97 described herein may communicate one or more signals related to measurement of a force. In some embodiments, one or more of the sensors or sensor arrays 51a, 51b, 97 may include signaling means for indicating a tension or other force that is outside of an acceptable force value. For example, if a force acting on the actuator 89 (or on some other part of a coupling, such as the connector 13, for example) exceeds a maximum allowed value or is less than a minimum allowed value an appropriate signal may be provided. For example, as shown in FIG. 15, a sensor or sensor array 97 may include an indicator 53. The indicator 53 may, for example, provide a visual or other indicia to communicate, for example, that a force representative of an undesirable load applied on a pipe 7 has been detected. Alternatively, as shown in FIG. 8A, an indicator 53 may be provided as part of a band 49. Of course, other means of indicating a condition related to an applied tension or load may also be used. For example, an audible alarm may be initiated so as to alert a worker that an undesirable force has been detected. In some embodiments, either or both of sensor or sensor arrays 51a, 51b (or sensor or sensory array 97) may include signaling means (e.g., wireless signaling capability as may be provided via a transceiver) to communicate signals externally to a remote computer, such as directly or through one or more routers. For example, in some embodiments, a remote computer may receive sensor signals output from various different sensor or sensor arrays 51a, 51b, 97. The remote computer may then communicate alarms should unacceptably high loads or forces be detected. In some embodiments, a group of couplings may be remotely monitored. Changes in a measured force on a given coupling (or at least changes unrelated to adjustment of the coupling by a worker) may be evaluated. If any unsafe changes are detected, an alarm or warning may be triggered.

As described above, in some embodiments, a connector 13 may be embodied as a hook. However, in other some embodiments, connector 13 may be embodied as any of an automotive seatbelt-style buckle, cam buckle, a side-release buckle, or a stab-lock style buckle. For example, in the illustrated embodiment shown in FIGS. 3A & 3B, the connector 13 is shown as an automotive seatbelt-style buckle including a buckle clip 117. The clip 117 may be received within a buckle receiver 115 positioned on the receiving mount 113. In some embodiments, the receiving mount 113 may be positioned at or adjacent the second end 11 of the saddle 3. Thus, as shown in FIG. 3B, the band 4 may extend across the pipe 7 (seated cradled in the saddle 3) so that the band 4 is secured in place and generally extends from the first end 9 to the second end 11 of the saddle, the coupling 20 encircling the pipe 7. Inserting the buckle clip 117 into the buckle receiver 115 may securely engage the buckle. In some embodiments, a release button 119 may be provided as may be depressed so as to release the buckle clip 117 from the buckle receiver 115.

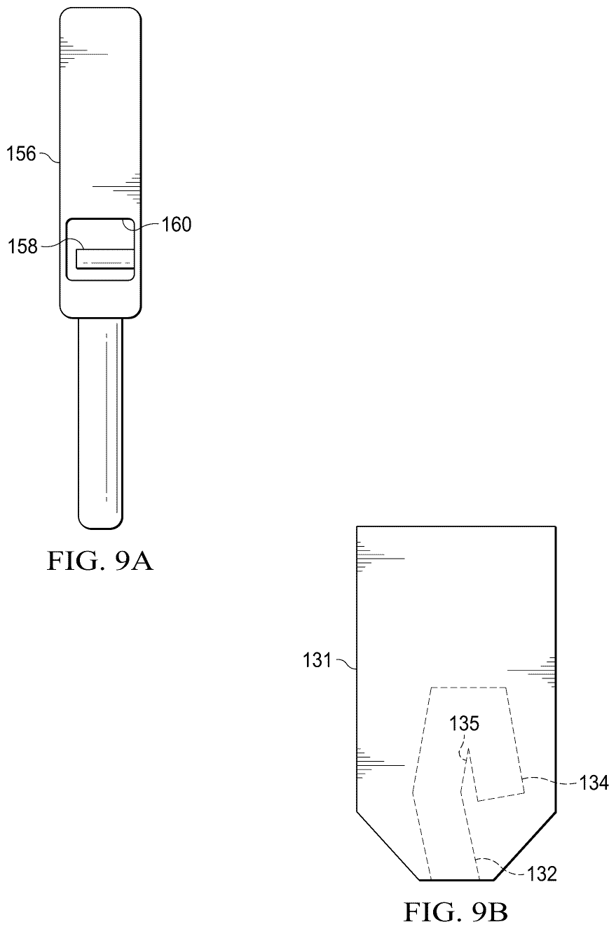

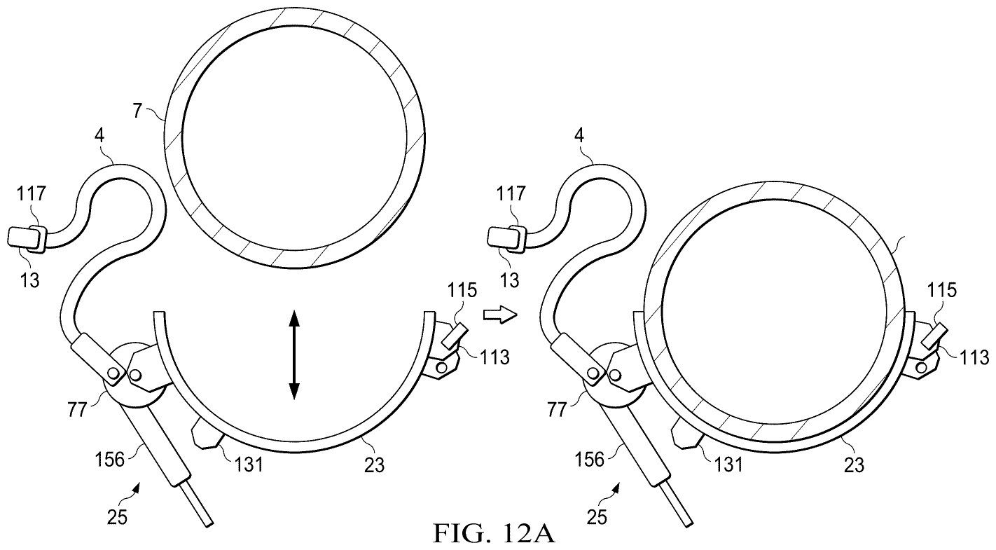

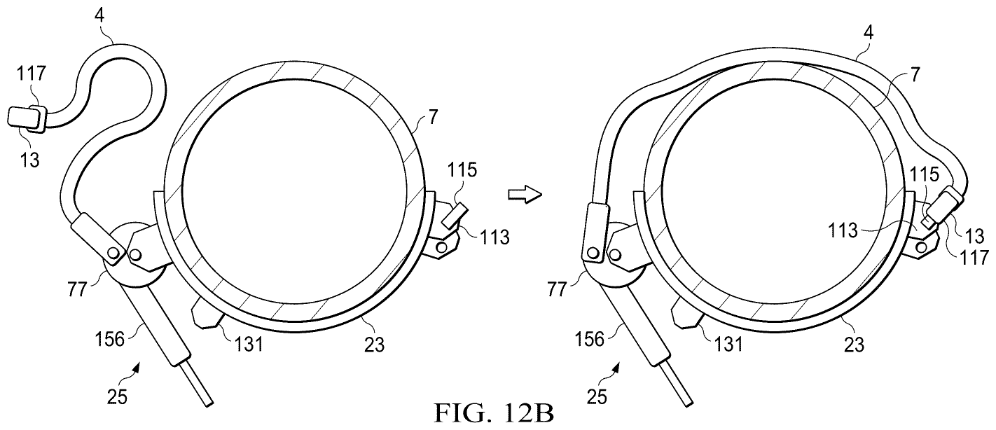

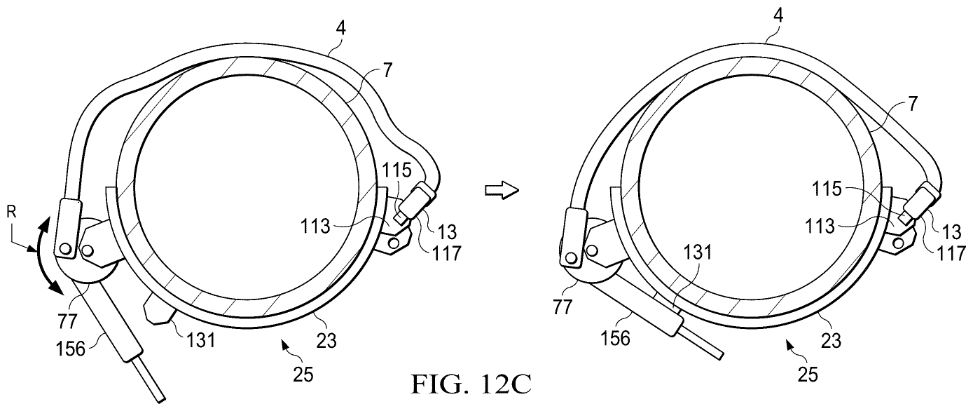

As shown in FIGS. 3A, 3B and FIGS. 4A, 4B (see also FIG. 12C), a lever 56, 156 may be adjusted so as to engage with a receiving mount 31, 131. For example, as shown in FIGS. 3A & 3B, lever 56 may be rotated R1 so that the mount 31 is received within a cutout (not shown) formed within the lever 56. A locking pin 57 may then be inserted through aligned holes 81, 83 so as to secure the lever 56 in place. Similarly, as shown in FIGS. 4A & 4B, lever 156 may be rotated R2 for engagement with mount 131. In some embodiments, the lever 156 may include an engaging rod or pin configured for mounting within a shaped slot formed within a receiving mount 131. For example, FIGS. 9A and 9B show, respectively, an embodiment of lever 156 and an associated receiving mount 131 configured for engagement therewith.

As shown in FIG. 9A, the lever 156 may include a pin or rod 158. As shown, for example, in FIG. 9A, the pin or rod 158 is provided within a cut out portion 160 of the lever 156. However, in other embodiments, the pin or rod 158 may be disposed differently. The pin or rod 158 may be shaped so that it may be received within a groove or slot 132 of the receiving mount 131 when the lever 56 is rotated R2 as shown in FIGS. 4A & 4B. In some embodiments, the receiving mount 131 may include a groove or slot 132 including a catch portion 134. The pin 158 may be guided by the groove or slot 132 into catch portion 134 when the lever 156 is rotated for engagement with the receiving mount 131. In some embodiments, the pin 158 may be mounted within the lever 156 so that it is biased (e.g., using a compression spring or other biasing means) so as to urge the pin 158 in a position within the catch portion 134 of the slot 132. One or more of pin 158 or pivot pin 22 (see FIGS. 4A & 4B) may be mounted so as to accommodate movement of the pin 158 within the slot 132 so that it may become seated in the catch portion 134. For example, in some embodiments, either or both of the pins 22, 158 may be mounted using a bushing, sleeve, or washer that may help to accommodate movement of the pin 158 through the slot 132. For example, either or both of the pins 22, 158 may be mounted in a shaped hole, or mounted using an elastomeric sleeve or washer that allows at least some give when guiding the pin 158 through the slot 132. In some embodiments, a lever 156 including a pin or rod 158 configured for engagement with a slot 132 may work together with a locking pin 57 when securing a lever 156 in place.

Another embodiment of a coupling 120 is shown in FIG. 5. Notably, the coupling 120 includes a saddle 3 including a coating or liner material 80 on the inner face 5 of the saddle 3. A coating or lining 80 may, for example, help to prevent marring of the pipe surface. In some embodiments, the coating or lining 80 may be formed of a compressible material. The coating or lining may, for example, become compressed as may be necessary to better comply with the overall shape of a pipe 7 when a securement band 4, 49 (not shown in FIG. 5) is engaged over the pipe 7 and tightened, thereby helping to distribute forces more evenly over the outer surface of the pipe 7.

FIG. 6 shows another embodiment of a coupling 200. In some embodiments, the coupling 200 may provide a curved plate 23 of reduced overall length as compared, for example, to the illustrated curved plate 23 shown in FIGS. 1-5. For example, the coupling 200 may be sized so that the curved plate 23 provides a base for mounting of other pieces (e.g., brackets and mounts) but which is otherwise sized so that a relatively longer band 4, 49 (not shown in FIG. 6) may be used to encircle a pipe 7. The coupling 200 may, for example, provide a light weight coupling 200 that may be readily carried and used by a worker in a method of construction and/or repair of industrial piping.

FIG. 7 shows an elevational view of another alternative embodiment of a saddle 33. Generally, unless the context indicates otherwise, the saddle 33 may be used in place of the saddle 3 in embodiments described herein. In some embodiments, one or more features of the saddle 33 (e.g., ribs or wings) may be used with the saddle 3. As shown in FIG. 7, a saddle 33 may include one or more support ribs 37. Support ribs 37 may, for example, be used to strengthen the saddle 33. As shown in FIG. 7, in some embodiments, a saddle 33 may further include a pair of side wings 39. Side wings 39 may, for example, be configured so as to help distribute forces and alleviate stress when a coupling 2, 20, 120, 200, 220 is used to mount scaffolding to a pipe, or vice versa. In some embodiments, side wings 39 may be used to provide a saddle 33 suitable for use in a relatively light weight coupling 2, 20, 120, 200, 220. Although the side wings 39 are illustrated in FIG. 7 as rectangularly shaped tabs other geometry or shapes of side wings may be used in some embodiments. For example, in some embodiments, the position, shape, or both of side wings 39 may be selected to help distribute various loading stresses which may be subjected on a given section of piping of certain geometry when scaffolding of a given weight or geometry is secured thereto.

FIG. 8A and FIG. 8B show, respectively, alternative embodiments of bands 49, 59. Generally, unless the context indicates otherwise, either of the bands 49, 59 may be substituted in place of the band 4 in some embodiments described herein. As shown in FIG. 8A, a band 49 may include one or more sensors or sensor arrays 51a, 51b. For example, a sensor array may comprise a plurality of sensors including at least one sensor suitable for detecting band tension. In some embodiments, one or more strain gauges or force sensors may be included among a plurality of sensors of senor arrays 51a, 51b. In some embodiments, a force sensor may be configured for measuring a force suitable for estimating or calculating a weight, stress, or strain disposed on a connector 13. In some embodiments, a sensor or sensor array 51a, 51b may comprise a load cell. A load cell may, for example, operate by means of changes in electrical resistance of a component of the load cell when walls of the load cell are placed under strain and change shape. A load cell may, for example, measure various forces including but not limited to tension, compression, and shear forces. In some embodiments, a part of a load cell may be capable of rotation and may be capable of measuring a torque. A load cell under strain may be physically deformed in the operation of measuring a force with physical changes in the shape of the load cell providing an electrical signal (e.g., a change in voltage or current proportional to the physical change in shape) that may be measured. In some embodiments, a counterforce acting on the connector 13 and related to band tension may be detected. Likewise, a counterforce provided on the connector 13 and related to the weight of a saddle 3 and/or related scaffolding mounted thereto may be detected.

Another alternative embodiment of a band 59 is shown in FIG. 8B. The band 59 may be configured to stretch around or over irregularities of a pipe, conduit, or beam upon which a coupling is mounted. For example, as shown in FIG. 8B, the band 59 may be formed as a mesh. Openings in the mesh may sometimes be configured to fit around a valve or other protruding feature of a pipe 7.

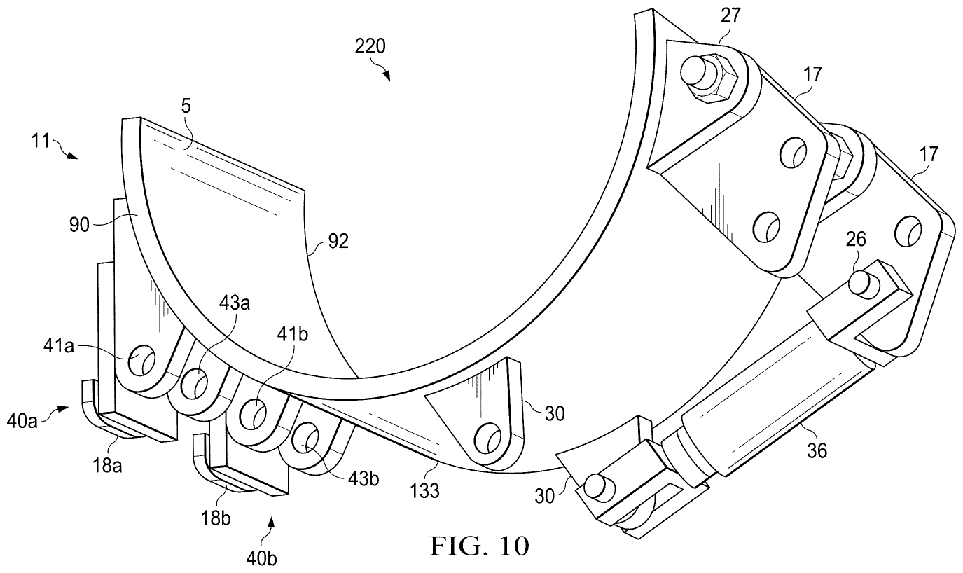

Another embodiment of a coupling 220 is shown in FIG. 10. As shown therein, in some embodiments, a hook plate 18 or other structure suitable for engagement with a connector 13 may be provided on either side of a coupling 220. For example, a first hook plate 18a may be provided on a first side 90 of the coupling 220. A second hook plate 18b may be provided on a second side 92 of the coupling 220. A worker may, for example, choose to mount a hook 13 from either a first side 90 or a second side 92 of the coupling 220 and choose to connect a flexible band's hook 13 to one of a pair of hook plates 18a, 18b located, respectively, on either the first side 90 or the second side 92 of the coupling 220. In some embodiments, a pair of flexible bands 4 may be used with a first flexible band connected to the hook plate 18a and a second flexible band connected to the hook plate 18b. In other embodiments, a single flexible band may be as wide as the saddle, and may require connection at multiple points at each end. Thus, for example, one end of a flexible band may be coupled to each tensioning arm 17 shown in FIG. 10. A wide band may, for example, allow the flexible band to support the weight of a pipe rather than the saddle in instances in which pipe orientation and scaffold configuration require placement of a coupling saddle over a pipe, or more to one side of a pipe, rather than under it. Likewise, a first scaffold connector 40a may include a pair of aligned holes 41a, 43a for receiving a connecting pin 64 when mounting scaffolding thereto. A second scaffold connector 40b may include a second pair of aligned holes 41b, 43b for receiving a second connecting pin 64 when mounting scaffolding thereto.

The coupling 220 may include a relatively wide saddle 133. A relatively wide saddle 133 may, for example, be used to configure a coupling 220 to bear high loads and loading stresses without significant strain as may be required, for example, when it is desired to mount extensive scaffolding thereto. As shown by the coupling 220, in some embodiments, connectors and related brackets 27, 30, 40 may also be included in pairs. For example, connectors and/or brackets 27, 30, 40 may be included in pairs in a mirrored pattern about a longitudinal axis of the coupling 220. The coupling 220 may be used with a tensioning assembly 15. For example, in the illustrated embodiment the coupling 220 includes a tensioning assembly 15 embodied as a tensioning arm 17 or cam coupled with an adjustment assembly 19. Adjustment assembly 19 may for example, comprise a turnbuckle, rotation of a body 36 portion thereof allowing for extension or retraction of the turnbuckle and rotation of the tensioning arm 17.

The couplings 2, 20, 25, 120, 145, 200, 220 described herein may be used in a method for supporting scaffolding using a pipe, or vice versa. For example, scaffolding may be secured to one or more pipes using a coupling 2, 20, 25, 120, 200, 220. In some embodiments, the couplings 2, 20, 25, 120, 200, 220 herein may alternatively interface with supporting beams or columns of a pipe rack, or other available column or beam in an industrial facility. Accordingly, scaffolding may be flexibly extended from the existing structure of an industrial facility. This may, for example, be used to provide access to areas of an industrial facility that may be difficult to reach, including, for example, areas around a distillation or rectification column or offshore oil platform. Scaffolding may, for example, be extended for performing necessary maintenance (e.g., pigging, cleaning, painting, or repairs) in and around such confined areas. Alternatively, a coupling may be supported by scaffolding so that a pipe 7 may be secured thereto during installation, maintenance, and/or repair of industrial piping. For example, a new section of piping may be supported by existing scaffolding using a coupling 2, 20, 25, 120, 145, 200, 220 as described herein and aligned in position for installation once a damaged section of piping has been removed.

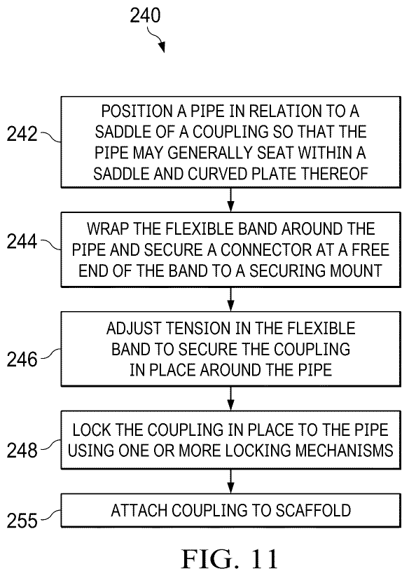

FIG. 11 is a flowchart of an embodiment of a method 240 for coupling a scaffold to a pipe. FIGS. 12A-12C are associated figures showing, by way of example, how the coupling 25 (also shown in FIGS. 4A & 4B) may engage with the pipe 7 throughout various steps described in the method 240. However, it should be understood that, in some embodiments, other couplings 2, 20, 120, 145, 200, 220 (or other couplings described herein) may also be used with the method 240. Accordingly, in reference to different steps in the method 240 both coupling 25 (as shown in FIGS. 12A-12C) and other couplings 2, 20, 120, 145, 200, 220 and/or other components may be referred to.

As shown in FIG. 11 at step 242 of the method 240 (with additional reference to FIG. 12A), a pipe 7 and a coupling 25 may be positioned relative to each other so that the pipe 7 may sit cradled within a saddle 3 of the coupling 25. For example, the pipe 7 may be one pipe included among industrial piping, as may, for example, include either process or utility piping for an industrial facility. In the illustrated embodiment shown in FIG. 12A, the pipe 7 is shown oriented in a horizontal geometry. However, in other embodiments, a coupling 2, 20, 25, 120, 145, 200, 220 may be secured to piping with a different geometry. For example, piping may be oriented vertically or with some other geometry.

As shown in FIG. 12A, an adjustment lever 156 may be positioned in a first position when the pipe 7 is seated within the saddle 3 of the coupling 25. With the lever 156 in this first position, the tensioning arm 77 may likewise be positioned so that an adequate length of the flexible band 4 may be available so that that a user may easily wrap the flexible band 4 around the pipe 7 when the pipe 7 sits cradled in the saddle 3. In another example, a turnbuckle 19 may be held in a first position so as to provide a length of the flexible band 4 so that a user may easily wrap the flexible band 4 around the pipe 7. For example, a turnbuckle 19 may be adjusted to a first position by rotating a body 36 of the turnbuckle 19 to an initial or set position. Still in another example, a lever 56 (see, e.g., coupling 20 shown in FIGS. 3A & 3B) may control the position of the tensioning arm 17. With the tensioning arm 17 and lever 56 positioned in the position show in FIG. 3A, an adequate length of the flexible band 4 may be available so that that a user may easily wrap the flexible band 4 around the pipe 7 when the pipe 7 sits cradled within the saddle 3.

As shown at step 244, a flexible band of a coupling may be wrapped around a pipe. A connector at a free end of the band may then be secured to a corresponding connector. For example, as shown in FIG. 12B, the flexible band 4 of the coupling 25 may be wrapped around the pipe 7 and a connector 13 may be engaged with an associated receiving mount 113. The lever 156 may remain positioned in a first position (e.g., disengaged from its mount 131) when the band 4 is wrapped around the pipe 7. Thus, the tensioning arm 77 may be positioned so as to provide an adequate length of the band 4 so that the clip 117 may be easily received by buckle receiver 115. For example, as shown in the right side image of FIG. 12B, the band 4 may remain loose or slack in a relaxed state when the clip 117 of the connector 13 is engaged with the receiving mount 113.

As shown at step 246 tension in the flexible band 4 may then be adjusted. For example, as shown in FIG. 12C, a user may manually actuate the lever 156 so that the lever 156 is engaged with its receiving mount 131. For example, actuation of the lever 156 may move the tensioning arm 17 from its first position (shown in FIG. 12C on the left) to the second position shown in FIG. 12C on the right. Alternatively, a lever 56 as shown in FIGS. 3A & 3B may be configured so that it engages with a mount 31 thereby rotating the tensioning arm 17 to the position shown in FIG. 3B. In another example, as shown in FIG. 2, a turnbuckle 19 may be adjusted so as to rotate R the tensioning arm 17 so as to apply tension on the flexible band 4. In other examples, an actuator 89 may be actuated so as to apply tension to the flexible band 4. In some embodiments, a tensioning adjustment routine may be executed when adjusting tension in the flexible band 4. For example, actuator 89 may be adjusted so that its length is changed. Signal data provided from sensor array 97 (or other sensors 51a, 51b) may provide feedback during this adjustment. For example, the band 49 may be used in place of the band 4 in the illustrated embodiment shown in FIG. 1. As a user adjusts the turnbuckle 19, indicator 53 may provide feedback regarding forces on connector 13 or tension in the band 49. In one example, a green light may indicate an appropriate level of force (e.g., an appropriate level to secure the coupling 2 to the pipe 7) has been applied. A red light may indicate that an unacceptable level of force has been applied. Of course, other approaches for indicating an appropriate level of adjustment such as through different visual or audio queues may also be provided.

As shown in step 248, one or more locking mechanisms may further be used to help secure the flexible band 4 in place around the pipe 7. For example, in some embodiments, rotation of the lever 156 for engagement with the receiving mount 131 may guide a pin 158 through a shaped slot 132 that moves the pin for engagement with a catch portion or nook 134 region of the shaped slot 132. In order to move the pin 158 from the catch portion or nook 134, the pin 158 may, for example, have to move over a ridge 135. In some embodiments, movement of the pin 158 through the slot 132 or over the catch 134 would require movement of the lever 156 in a way that moves the tension arm 77 in a direction that at least transiently increases tension in the band 4. Accordingly, a counterforce provided by the taut band 4 may tend to keep the pin 158 in the catch portion 134 of the slot 132. In other embodiments, other locking mechanisms, including, for example, a locking pin 57 or turnbuckle locking clip may be used to help secure a flexible band 4, 49, 59 in place around the pipe 7. For example, as shown in FIG. 3B, locking pin 57 may be received within an accepting aperture of the lever 56 and through a corresponding aperture of the receiving mount 31.

Once a coupling 2, 20, 25, 120, 200, 220 is secured to a pipe 7, as shown in step 255, scaffolding may then be secured thereto. Alternatively, a coupling 2, 20, 25, 120, 200, 220 may be secured to scaffolding (described further below). Once the coupling is secured thereto it may provide a saddle 3, 33, 133 for receiving a pipe 7. The pipe 7 may then be secured in place to the saddle as described, for example, in the steps 244, 246, and 248, using a flexible band and lever, for example, or using other structures as described herein.

In either case, the couplings 2, 20, 25, 120, 200, 220 described herein may provide at least one connector for engaging with scaffolding. For example, as shown for the coupling 220, a pair of scaffold connectors 40a, 40b may be disposed on opposite sides of the coupling 220. Similar scaffold connectors 40 are shown, for example, in each of the couplings 2, 20, 25, 120, and 200 (shown, respectively, in FIGS. 1, 3A, 4A, 5, and 6).

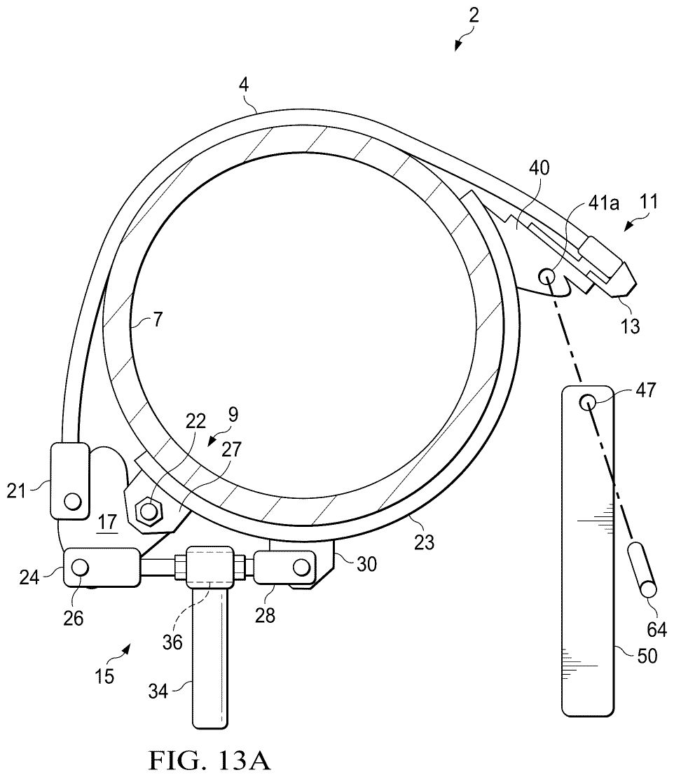

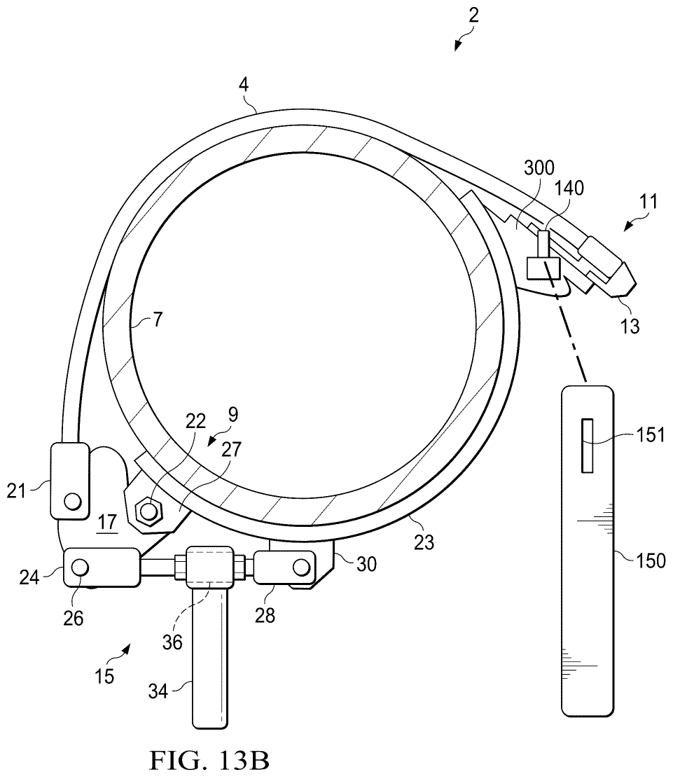

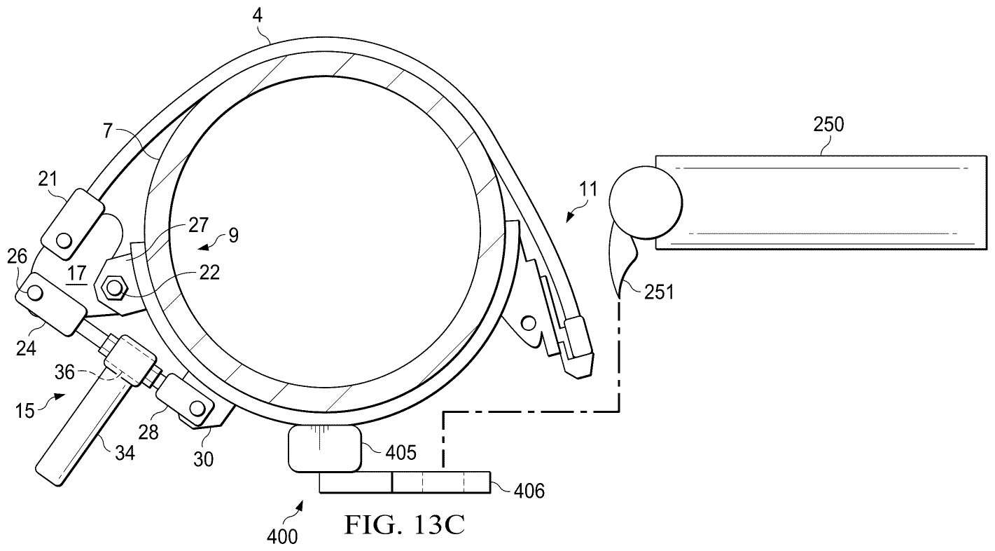

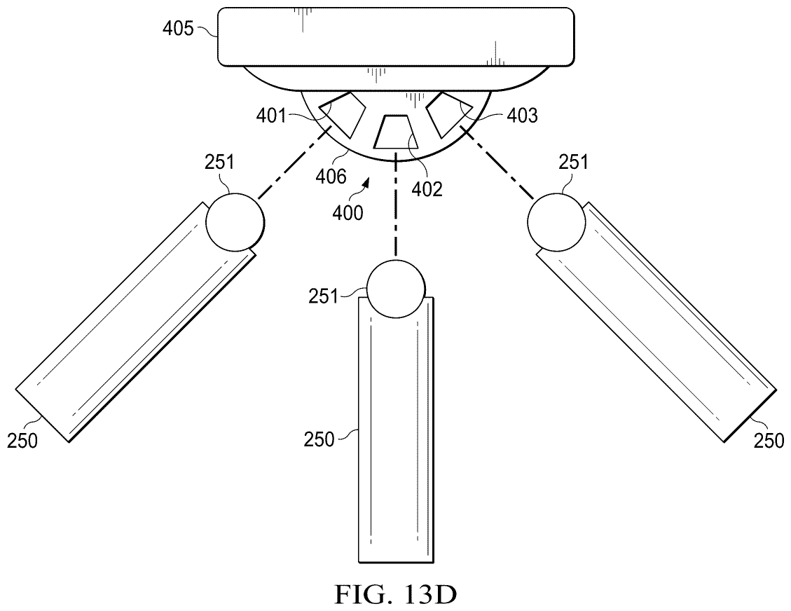

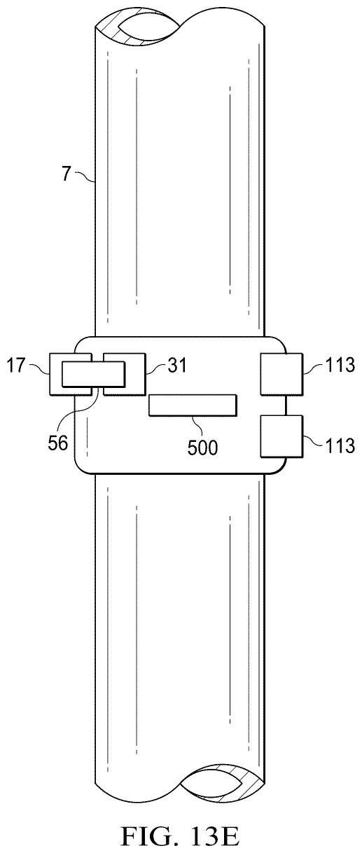

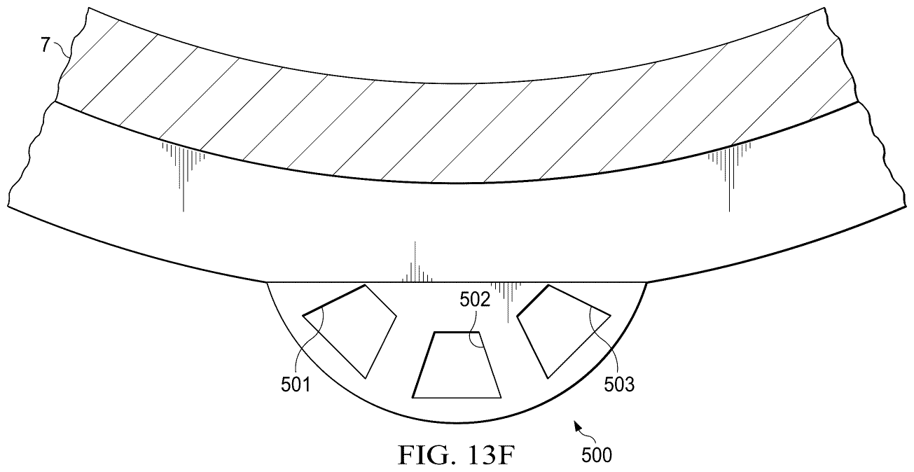

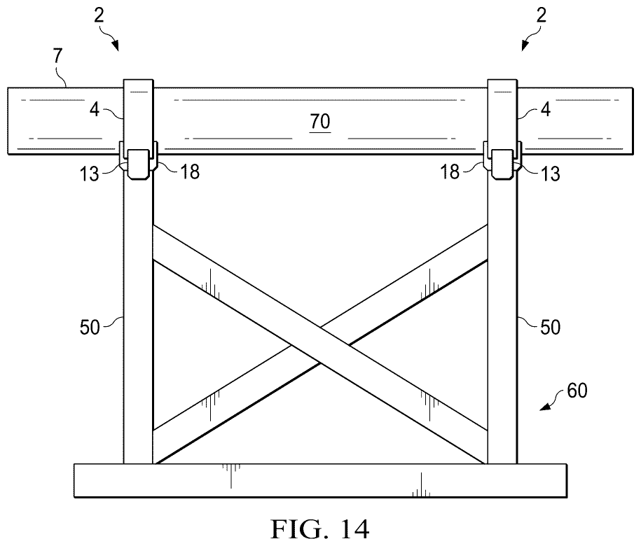

For example, as shown in FIG. 1, FIG. 3A, and FIG. 4A, a scaffold connector 40 may include a first hole 41 through which a connecting pin 64 (shown in FIG. 13A, for example) may be engaged. The scaffold connector 40 may also include a second aligned hole with the first hole 41 (not shown in FIG. 1, FIG. 3A or FIG. 4A, but see similarly configured connectors 40a, 40b shown in FIG. 10). In some embodiments, a connecting rod, screw, rivet, or other suitable engagement means may be used instead of a pin for connecting scaffolding to a connector. For example, in the illustrated example shown in FIG. 13A, the scaffold beam 50 may be generally aligned over the scaffold connector 40 so that the holes 41a, 41b of scaffold connector 40 are aligned with the opening 47 of scaffolding beam 50. Connected pin 64 may then be inserted through the aligned structures 41a, 41b and 47. Scaffold beam 50 may then serve as a base for adjoining additional scaffolding thereto. For example, FIG. 14 shows an embodiment of a scaffolding 60 including additional scaffolding which may be mounted to the pipe 70 through scaffold beams 50.

In other embodiments, a scaffold connector 40 may be configured differently. For example, in some embodiments, as shown in FIG. 13B, a scaffold connector 300 may include a hook 140 instead of or in addition to a hole 41. As shown therein, the hook 140 may be received in slotted opening 151 of the connecting beam 150. A connecting hook 140 may, for example, be suitable for use in some embodiments wherein a connecting beam 150 is suspended from a coupling. Accordingly, to disengage the beam 150 from scaffolding, the beam 150 may have to be raised over the hook 140 so that the weight of the beam 150 may tend to keep the beam 150 and coupling 2 in an engaged configuration.

In other embodiments, a scaffold connector 400 may include a plurality of receiving openings or recesses for accepting a connecting component (e.g., a wedge) of a scaffold. For example, an embodiment of a coupling including a scaffold connector 400 is shown in FIG. 13C and FIG. 13D. FIG. 13D is a view of the scaffold connector 400 from the topside of the connector 400. In FIG. 13D other components of the coupling as well as the pipe are removed so as to show the relevant structures for connection more clearly. As shown in FIG. 13D, the connector 400 may include a bracket 405 upon which a connecting plate 406 is mounted. The connecting plate 406 is shaped so that a plurality of recesses or openings 401, 402, 403 are provided and accessible to a scaffolding beam 250. In other embodiments, a connecting plate 406 may, for example, include a plurality of hooks 140. Beam 250 may, for example, include a wedge 251 that is configured for engagement with any one of the recesses or openings 401, 402, 403. A wedge may enable connection thereto with the weight of the scaffolding beam 250 pushing the wedge through a selected recess or opening 401, 402, 403. Advantageously, the connector 400 may allow for connection with scaffolding at any of various different angles. For example, using the recess or opening 403, scaffolding may be connected along a diagonal angle.

In each of FIGS. 13A-13D, the coupling is shown to include a saddle 3. The saddle 3 is shown engaged with a pipe 7 that is generally aligned horizontally. As shown in FIGS. 13E & 13F, a pipe 7 may be oriented vertically. As shown therein, a scaffolding connector 500 may be similarly configured like the connector 400. The scaffolding connector 500 includes a plurality of recesses 501, 502, 503 so as to allow for connection of a scaffolding beam at any of various different angles (similarly to that shown in FIG. 13D).

As shown in each of FIG. 1 and FIG. 10, in some embodiments, scaffold connectors 40 may be integrated along with a hook plates 18. For example, as best shown in FIG. 10, each pair of hook plates 18a, 18b and scaffold connectors 40a, 40b may be formed integrally with the saddle 133 at the second end 11 thereof. Likewise, as shown in FIG. 3, in some embodiments, scaffold connectors 40 may be generally integrated along with receiving mounting 113 at the second end 11 of the saddle 3.

However, in other embodiments, scaffold connectors 40, 300, 400 and hook plates 18 (or receiving mounts 113) may be separate structures and may be mounted at separate locations along a saddle. For example, as shown in FIG. 5, in some embodiments, a coupling 120 may include a scaffold connector 40. In the embodiment illustrated therein, the scaffold connector 40 may be connected at about a midpoint 45 of the saddle 3. Accordingly, a beam or part of scaffolding may be connected thereto, and the weight of the scaffold may apply a downward force on the coupling 120 that is centered on the saddle 3. This alignment may, for example, help to minimize risk of inadvertent rotation of the saddle 3. That is, in this configuration, weight of the scaffolding may be centered underneath the saddle 3 so that the saddle 3 tends to remain centered underneath a pipe 7 to which it is secured. As shown in FIG. 6, in some embodiments, a pair of scaffold connectors 40c, 40d or some other number of scaffold connectors may be connected to a single saddle 3. Forces applied on the combination of connectors 40c, 40d may work together to minimize forces that might tend to rotate the saddle 3, thereby helping to keep the saddle 3 aligned underneath a given pipe 7 to which a coupling 200 is secured. Thus, loads applied to a coupling 2, 20, 120, 200, 220 via scaffolding may be accommodated in various different ways with different geometries and arrangements of scaffold connectors 40, 300, 400.

Generally, piping systems as described herein may include, for example, process piping or utility piping. For example, process piping as described herein may be used for routing feedstock or processed feedstock in an industrial plant. Utility piping may be used for routing other materials (e.g., steam or nitrogen) in an industrial plant. In some embodiments, the couplings described herein may be configured for use in securing scaffolding to either of process or utility piping. Still in other embodiments, the couplings described herein may be configured for connecting to one or more supporting beams, pipe racks, or pipe bridges of an industrial facility. For example, in some embodiments, the couplings herein may alternatively be connected to supporting columns or beams comprising a pipe rack or bridge of an industrial facility. In some such embodiments, saddles as described herein may be formed in a suitable shape for interfacing therewith. For example, whereas some of the saddles described herein may include an arced plate as may be suitable for abutting against a cylindrical pipe, other embodiments, may be shaped differently (e.g., with straight or perpendicular oriented walls or faces) as may be appropriate for interfacing with rectangular or otherwise shaped beams or columns of an industrial facility. Generally, such couplings may be configured as appropriate for any given type of beam, column, or pipe rack (e.g., steel or reinforced concrete cement pipe rack) commonly used in an industrial facilities.

Although the foregoing specific details describe certain embodiments of this invention, persons of ordinary skill in the art will recognize that various changes may be made in the details of this invention without departing from the spirit and scope of the invention as defined in the appended claims and other claims that may be drawn to this invention and considering the doctrine of equivalents. Among other things, any feature described for one embodiment may be used in any other embodiment, and any feature described herein may be used independently or in combination with other features. Also, unless the context indicates otherwise, it should be understood that when a component is described herein as being mounted or connected to another component, such mounting or connection may be direct with no intermediate components or indirect with one or more intermediate components. Therefore, it should be understood that this invention is not to be limited to the specific details shown and described herein.

What is claimed is:

1. A scaffold coupling comprising:
a saddle shaped to receive a first portion of a pipe, the saddle including a first scaffolding connector;
a tensioning arm pivotably coupled to the saddle;
a flexible band having a first end and a second end, the first end coupled to the saddle and the second end coupled to the tensioning arm, the flexible band being configured for wrapping around a second portion of the pipe so that the coupling may surround the pipe; and
an adjustment assembly coupled to the tensioning arm, the adjustment assembly being configured for actuation so as to rotate the tensioning arm about the pivot.

2. The coupling of claim 1 wherein rotation of the tensioning arm about the pivot adjusts the tensioning arm between a first position and a second position, the flexible band being held in a relaxed state when the tensioning arm is positioned in the first position and held in a state of tension when the tensioning arm is positioned in the second position.

3. The coupling of claim 2, the tensioning arm being configured so that rotation of the tensioning arm between the first position to the second position adjusts the flexible band through an intermediate state of maximum tension.

4. The coupling of claim 1 wherein the saddle comprises a curved plate including an outer edge, the outer edge of the curved plate being shaped as a semi-circle.

5. The coupling of claim 4 wherein the curved plate includes an inner surface shaped to receive about ¼ to about ½ of a perimeter distance around the pipe.

6. The coupling of claim 4 wherein the outer edge of the curved plate is shaped as a half circle.

7. The coupling of claim 4, the saddle including a bracket, the pivot being secured to the bracket.

8. The coupling of claim 7, the bracket being fixedly mounted to said curved plate.

9. The coupling of claim 1, the adjustment assembly comprising a turnbuckle.

10. The coupling of claim 1, the adjustment assembly comprising a linear actuator.

11. The coupling of claim 1, the adjustment assembly comprising a lever.

12. The coupling of claim 1, the adjustment assembly comprising one of a turnbuckle, a lever, a stretching screw, and a linear actuator.

13. The coupling of claim 1, the adjustment assembly comprising a turnbuckle engaged with a ratchet handle.

14. The coupling of claim 1, the first connector comprising one or more apertures or hooks.

15. The coupling of claim 1, the first connector comprising a connecting plate including an array of apertures or hooks, individual apertures or hooks of the array being aligned at different angles.

16. The coupling of claim 1, the flexible band including a second connector configured for engagement with a third connector of the saddle.

17. The coupling of claim 16, the second connector comprising a hook and the third connector comprising a hook plate.

18. The coupling of claim 16, the second connector comprising a seatbelt-style buckle, a side-release buckle, or a stab-lock style buckle.

19. The coupling of claim 1, the flexible band including a first force sensor configured for outputting a sensor signal indicating a level of tension in the flexible band.

20. A coupling comprising:
a saddle shaped to receive a cylindrically shaped pipe so that a first portion of the pipe may be received within the saddle, the saddle comprising:
a first connector configured for engagement with scaffolding; and
a curved plate, the curved plate including an inner surface shaped to abut against the pipe when the pipe is received within the saddle;
a tensioning arm mounted to the saddle through a pivot;
a flexible band being secured to the tensioning arm, the flexible band being configured for wrapping around a second portion of the pipe so that the flexible band may extend around the second portion of the pipe for connection to the saddle; and
an adjustment assembly coupled to the tensioning arm, the adjustment assembly being configured so as to rotate the tensioning arm about the pivot so as to adjust the tensioning arm between a first position and a second position, the flexible band being held in a relaxed state when the tensioning arm is held in the first position and held in a state of tension when the tensioning arm is held in the second position.

21. The coupling of claim 20, the tensioning arm being configured so that rotation of the tensioning arm between the first position and the second position adjusts the flexible band through an intermediate state of maximum tension.

22. The coupling of claim 20, the tensioning assembly comprising a lever, the lever being manually adjustable so as to rotate the tensioning arm between the first position and the second position.

23. The coupling of claim 22, the saddle further comprising a mount for receiving the lever when the lever is manually adjusted so as to rotate the tensioning arm between the first position and the second position.

24. The coupling of claim 20, said curved plate including an outer edge, the outer edge of the curved plate being shaped as a semi-circle.
